(19) United States
(12) Patent Application Publication
(10) Pub. No.: US 2010/0210445 A1
(43) Pub. Date: Aug. 19, 2010

(54) REACTIVE, LIQUID CERAMIC BINDER

(76) Inventors: Tadeusz von Rymon Lipinski, Bonn (DE); Sascha Herrwerth, Essen (DE); Thomas Ebbrecht, Wetter/Ruhr (DE); Frank Koenig, Gelsenkirchen (DE); Michael Ferenz, Essen (DE)

Correspondence Address: FROMMER LAWRENCE & HAUG, 745 FIFTH AVENUE- 10TH FL., NEW YORK, NY, 10151, US

(21) Appl. No.: 12/370,733

(22) Filed: Feb. 13, 2009

(30) Foreign Application Priority Data
Feb. 13, 2009 (DE) 102008000287.9

(51) Int. Cl. C04B 35/16; C09K 3/00; C07F 7/08; C07F 7/00

(52) U.S. Cl. 501/133; 501/154; 252/182.3; 556/430; 556/443; 977/811

(57) ABSTRACT

The present patent application relates to a reactive ceramic binder in liquid form which is suitable for producing ceramic products from ceramic powder, characterized in that the reactive, liquid ceramic binder comprises liquid organomodified siloxane compounds having organoalkoxysiloxane units of the general formula (I)

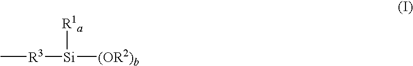

where the radicals R¹ are, independently of one another, identical or different alkyl, alkaryl or aryl radicals which may be interrupted by ether functions, the radicals R² are, independently of one another, identical or different radicals selected from the group consisting of H and/or alkyl radicals having from 1 to 6 carbon atoms, the radicals R³ are, independently of one another, identical or different divalent, saturated or unsaturated hydrocarbon radicals which have from 1 to 30 carbon atoms and may be interrupted by ether functions and a is greater than or equal to 0 and less than or equal to 2.5 and b is greater than 0 and less than or equal to 3, with the proviso that a+b is greater than or equal to 1 and less than or equal to 3.

This application claims benefit under 35 U.S.C. 119(a) of German patent application 102008000287.9, filed on 13 Feb. 2008.

Any foregoing applications, including German patent application DE 102008000287.9, and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

The present invention relates to a reactive, liquid binder suitable for binding ceramic particles for producing ceramic products, in particular refractory, ceramic products, from ceramic powder. The invention further relates to the use of the binder and a process for producing ceramic products of the above-mentioned type, and also ceramic products as such, with refractory, ceramic products being particularly preferred according to the invention.

Refractory ceramic products, hereinafter also referred to as “RF materials”, are used for protection against high temperatures in numerous industrial plants. The most important types of refractory material are:
shaped dense products having a porosity of ≦45% by volume, e.g. bricks and components,
shaped heat-insulating products having a porosity of ≧45% by volume, e.g. lightweight firebricks,
unshaped refractory products such as fire concretes, ramming compositions, spray compositions, tamping compositions and the like.

Conventional refractory products are produced from pulverulent raw materials. The particle size of the powders is in a relatively wide range, from a few microns to a number of millimetres. Raw materials having a particle size of >10 mm are sometimes also used. Accordingly, the powders are referred to as coarse, medium, fine and very fine particle fraction.

The use of solid, branched or crosslinked, high molecular weight organomodified siloxanes or solid phenylmethyl-polysiloxanes in ceramic products is known from the prior art.

WO 93/01146 (U.S. Pat. No. 5,741,842) relates to a binder for thermoplastic moulding compositions, which comprises at least one thermoplastic silicone resin having a softening point in the range from 30° C. to 200° C., for the production of mouldings composed of ceramic or metal from corresponding ceramic or metal powders. Such thermoplastic moulding compositions are employed, inter alia, in processes such as injection moulding, extrusion or hot pressing in which a temperature-dependent flow behaviour is necessary. The silicone resins are, according to the invention, preferably used without catalysts, so that further crosslinking and curing do not occur during the shaping process.

The use of these abovementioned solid siloxane compounds as ceramic binders has the disadvantage that very homogeneous mixtures with ceramic materials cannot be produced or can be produced only unsatisfactorily. In addition, a sufficiently high green strength of the shaped ceramic product made of ceramic particles cannot be achieved without heat treatment at relatively high temperatures when such binders are used. A further disadvantage of the binders known in the prior art is that very high firing temperatures, usually above 1000° C., are necessary to obtain refractory ceramic products having satisfactory mechanical properties such as cold compressive strength. In addition, high pressures and long firing times, which is associated with a high energy consumption, are required.

WO 93/01146 also relates to a binder for thermoplastic moulding compositions which are plastically processed exclusively above the softening point of the silicone resin and introduced under pressure into moulds whose temperature is below the softening point of the silicone resin. Shaped, ceramic products having a satisfactory green strength cannot be produced according to the teachings of WO 93/01146 by nonplastic processing, for example by uniaxial or isostatic pressing, by slip casting, by tamping, spraying, in particular at temperatures below the softening point of the silicone resin, or the like. In addition, unshaped ceramic products, in particular refractory materials, cannot be produced using the binder and process described in WO 93/01146 (U.S. Pat. No. 5,741,842).

DE 10 2006 020 967 describes reactive, liquid ceramic binders which are suitable for producing ceramic products, where the reactive, liquid ceramic binder comprises organomodified siloxane compounds and the organomodified siloxane compounds contain organoalkoxysiloxane units of the following general formula:

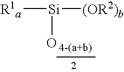

where
R¹ is an alkyl radical and/or aryl radical,
R² is H and/or an alkyl radical having from 1 to 4 carbon atoms,
a is greater than or equal to 0 and less than or equal to 2 and
b is greater than 0 and less than or equal to 3, with the proviso that a+b is greater than or equal to 1 and less than or equal to 4.

The compounds described here can be prepared in various ways. Possible synthesis routes are, for example, described in DE 33 12 911 (U.S. Pat. No. 4,486,476), EP 0 124 748 (U.S. Pat. No. 4,486,476) and in Noll, Chemie and Technologie der Silicone (1968), Verlag Chemie. However, the use of industrially available raw materials generally leads to products in which the organoalkoxysiloxane units are generally located at the ends of the siloxane backbone. In addition, the preparation of compounds in which a plurality of alkoxy functions are bound to one siloxane unit is complicated. However, to optimize the product properties, it can be advantageous to prepare products having particular siloxane topologies.

It has now surprisingly been found that ceramic products, in particular refractory ceramic products, which have an unexpectedly high cold compressive strength can be made available even at low treatment temperatures by using reactive, liquid ceramic binders comprising organomodified siloxane compounds having organoalkoxysiloxane units of the general formula (I)

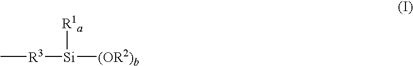

where
the radicals R¹ are, independently of one another, identical or different alkyl, alkaryl or aryl radicals which may be interrupted by ether functions, preferably methyl or phenyl, in particular methyl, the radicals R² are, independently of one another, identical or different radicals selected from the group consisting of H and/or alkyl radicals having from 1 to 6 carbon atoms, preferably methyl or ethyl,
the radicals R³ are, independently of one another, identical or different divalent, saturated or unsaturated hydrocarbon radicals which have from 1 to 30 carbon atoms and may be interrupted by ether functions, preferably —(CH₂)ₙ— where n=1 to 11, in particular —CH₂—CH₂—,
a is greater than or equal to 0 and less than or equal to 2.5 and
b is greater than 0 and less than or equal to 3, with the proviso that a+b is greater than or equal to 1 and less than or equal to 3.

Such organomodified siloxane compounds can be prepared, for example, by hydrosilylation of alkoxy-functional vinylsilanes by means of SiH-functional siloxanes. In this way, it is possible to obtain a wide variety of siloxane topologies in a simple fashion since a wide variety of SiH-functional siloxanes are available. In addition, further organic radicals can be bound to the siloxane skeleton in a simple manner by cohydro-silylation, for example to hydrophobicize or hydrophilicize the product in a specific way.

The formula (I) is an average formula of the organoalkoxysiloxane units of the liquid, organomodified siloxane compound.

The proportion of H in R² can be greater than or equal to 0% and less than or equal to 10%, preferably greater than or equal to 0% and less than or equal to 5%, particularly preferably greater than or equal to 0% and less than or equal to 1% and very particularly preferably 0%.

R²═H describes SiOH functions and their mole fraction based on the total molar amount of SiOR² groups occurring in this structural element.

The term “ceramic product” encompasses, inter alia, ceramic compositions, dimensionally stable ceramic bodies and refractory ceramic products.

The reactive, liquid ceramic binder preferably comprises at least one liquid organomodified siloxane compound having organoalkoxysiloxane units of the general formula (I).

Apart from the siloxanes according to the invention, further liquid, organomodified siloxane compounds which bear organoalkoxysiloxane units and are not described by formula (I) can also be added to the liquid ceramic binders.

The term “liquid” as used for the purposes of the present invention means that the respective substance, in particular the liquid, organomodified siloxane compound or the corresponding mixture, is liquid at room temperature, i.e. 25° C.

Preference is given to the substituents R¹ and/or R² and/or R³ of the liquid, organomodified siloxane compound(s) being defined as follows:
the radicals R¹ are phenyl and/or a C₁-C₁₆-alkyl radical, with preference being given to R¹═C₁-C₁₂-alkyl radical, more preferably R¹═C₁-C₈-alkyl radical, particularly preferably R¹═C₁-C₄-alkyl radical, with greatest preference being given to R¹=methyl and/or ethyl; and/or
the radicals R² are each H, methyl, ethyl, propyl, isopropyl, butyl, tert-butyl, with methyl and/or ethyl being most preferred;
R³ is —(CH₂)ₙ— where n=1 to 11, preferably n=1 to 3, particularly preferably n=2.

According to the invention, it can also be preferred that a=0 to 2.5, preferably a=0 to 1 and more preferably a=0 to 0.5, with the proviso that a+b≦3 and preferably a+b=3.

According to the invention, it can also be preferred that b=0.1 to 3, preferably b=0.5 to 3, more preferably b=2 to 3 and particularly preferably b=3, with the proviso that a+b≦3 and preferably a+b=3.

The reactive, liquid organomodified siloxane compounds according to the invention can have a number average molecular weight of from 500 to 20 000 g/mol, preferably from 750 to 15 000 g/mol, more preferably from 1000 to 10 000 g/mol, even more preferably from 1200 to 8000 g/mol and particularly preferably from 1200 to 7000 g/mol.

Furthermore, the reactive, liquid ceramic binder of the invention can contain a solvent selected from the group consisting of organic solvents, preferably liquid hydrocarbons, in particular solvents having a boiling point in the range from 40° C. to 100° C., for example alcohol and/or acetone and mixtures thereof. The addition of solvents allows, for example, the miscibility with ceramic powders to be improved.

It can be preferred that the reactive, liquid ceramic binder, in particular a ceramic binder containing liquid, organomodified siloxane compounds, is used in admixture with water, particularly preferably as an aqueous emulsion. The use of an aqueous emulsion in combination with the ceramic powder allows, for example, a composition which can be cast or injected even at room temperature to be produced.

To improve the properties, for example in respect of processability, handling, drying process, firing process, strength, corrosion resistance and/or oxidation resistance, of the ceramic composition and/or ceramic product, at least one additive can be added to the ceramic binder, with this additive being different from the organomodified siloxane compound(s) based on the formula (I) and being selected from the group consisting of an inorganic binder, an inorganic salt of sulphuric acid, an inorganic salt of hydrochloric acid, an inorganic salt of phosphoric acid, magnesium chloride, magnesium sulphate, monoaluminium phosphate, alkali metal phosphate, alkali metal silicate, water glass, an organic binder, cellulose derivative, polyvinyl alcohol, water, organic solvents, mould release agents, stabilizers, organic pigments, inorganic pigments, nonoxidic materials, preferably carbon, metal powders, metal fibres, ceramic fibres, glass fibres, natural fibres, synthetic fibres, metal oxides, borides, carbides, nitrides, oxynitrides, oxycarbides, silicides, polymers, catalyst and/or carbon fibres. The addition of very reactive nanosize, oxidic and/or nonoxidic powders can be preferred and the addition of nanosize metal oxides, nano-aluminium oxide and/or its precursors can be particularly preferred.

Further additives which can be used according to the invention, in particular for improving the processability, handling, green density and strength, etc., encompass setting retarders, setting accelerators, pressing aids, lubricants, thickeners, antifoams, fluidizers, sinter aids and the like.

Particular preference is given to using liquid, organomodified siloxane compounds of the binder according to the invention in combination with further additives such as organic and/or inorganic binders, water, organic solvents, functional additives such as carbon, borides, metal powders, carbides, silicides, oxides and the like.

Likewise, the use of ceramic binders in combination with hydraulic binders such as hydratable aluminium oxide (known as rho-aluminium oxide), calcium aluminate cement, portland cement, gypsum plaster, if appropriate together with water in variable amounts, can be advantageous.

Nanosize metal oxides, preferably nanosize aluminium oxide, can preferably be added to the ceramic binder, which can lead to an improved cold compressive strength of ceramic products.

It has also surprisingly been found that the use of the reactive, liquid ceramic binder of the invention in combination with a ceramic powder leads to stable, in particular refractory, ceramic products even at low firing temperatures.

Refractory ceramic products are generally and in the description of the present invention also referred to as refractory ceramic materials or RF materials.

A further advantage of the present invention is that ceramic products having a sufficient green strength can be produced by use of the reactive, liquid ceramic binder of the invention at temperatures of <30° C., preferably at room temperature.

It is advantageous that the firing temperature and/or the firing time and thus the energy consumption in the production of ceramic products, in particular refractory products, can be reduced by use of the ceramic binders of the invention. In addition, the CO₂ and NOₓ emission can be reduced when using fossil energy carriers as a result of the lower energy consumption.

It has also been observed that the firing times can, at least in most cases, be shortened without a deterioration in the material's properties, in particular the strength, of the ceramic products produced using the ceramic binders of the invention compared to conventional refractory ceramic products, i.e. refractory ceramic products produced according to the prior art.

Furthermore, it has been observed that there is advantageously no or at most only a slight decrease in the strength, i.e. cold compressive strength [MPa], of the material when using the reactive, liquid ceramic binder of the invention in the temperature range from, for example, 100° C. to 1000° C., preferably from 200° C. to 800° C.

The use of the reactive, liquid ceramic binder of the invention can lead to no or no significant formation of low-melting phases in the ceramic during the production process. This is advantageous since the occurrence of such phases is very disadvantageous for the material's properties, in particular with regard to their stability at high temperatures.

Another advantage of the reactive, liquid ceramic binder of the invention is that it gives, with or without addition of water, the ceramic product a high dimensional stability and can therefore also preferably be used for ceramic products which are susceptible to hydration, for example basic RF materials.

For the purposes of the present invention, ceramic products include dried, heat-treated and/or fired ceramic products. The term ceramic product as used in the present description also encompasses green bodies. In particular, the term ceramic product encompasses heat-resistant and/or refractory ceramic products (RF materials). Furthermore, products such as shaped bodies and materials which are a composite, i.e. are made up of a ceramic material and at least one other material or one other phase, are also included under the term ceramic product. These can also be present as at least one ceramic layer, preferably a ceramic surface coating.

Shaped and unshaped ceramic products, in particular heat-resistant and/or refractory, unfired and/or fired ceramic shaped ceramic bodies, unshaped refractory products, for example concretes, tamping compositions, casting compositions, coatings or surface coverings having excellent physical and mechanical properties and improved production parameters can be obtained by means of the reactive, liquid ceramic binder of the invention.

For the purposes of the invention, production parameters are, in particular, the parameters for producing the unshaped products, the unfired products, the green bodies and the fired ceramic products.

The reactive, liquid ceramic binder of the invention can be added to the ceramic powder in a proportion by weight, based on the total weight of the ceramic powder, of from 0.01 to 70% by weight, preferably from 0.1 to 50% by weight and more preferably from 0.5 to 30% by weight.

It has surprisingly been found that the reactive, liquid ceramic binder is effective even in significantly smaller amounts, based on the ceramic powder, than the compounds known from the prior art. Distinct effects can be achieved using amounts of the organomodified siloxane compounds of less than 5% by weight, based on the total weight of the ceramic powder. According to the invention, preference is given to amounts of the organomodified siloxane compounds in the range from 0.05 to <10% by weight, in particular from 0.1 to 5% by weight, particularly preferably from 0.5 to 3% by weight, in each case based on the amount of ceramic powder.

If the amount of the organomodified siloxane compounds is less than 0.01% by weight, it is very difficult to obtain a fired product having a high strength, while when more than 10% by weight, in particular more than 15% by weight, of the organomodified siloxane compounds are added, bloating of the fired product can be observed and its strength and the density of its microstructure can be adversely affected.

According to the invention, the reactive, liquid ceramic binder can be used for producing ceramic products, in particular shaped and unshaped, fired and unfired refractory, ceramic products, from ceramic powder(s).

The present invention further provides a ceramic composition which comprises the ceramic binder of the invention and ceramic powder.

The ceramic compositions can be used directly or firstly be processed to produce powders or granular materials.

In addition, it has surprisingly been found that ceramic compositions containing the liquid organomodified siloxane compounds can be processed even at temperatures below the softening point of solid, organomodified siloxane compounds.

According to the invention, preference can therefore be given to processing ceramic comprising ceramic powder and ceramic binder according to the invention only under pressure.

The ceramic compositions of the invention can be used for producing shaped and unshaped ceramic products and also for producing fired and unfired ceramic products.

Ceramic powders which can preferably be used for producing the ceramic compositions can be selected from the group consisting of coarse, medium, fine and very fine ceramic particles. Suitable ceramic particles can include all typical, oxidic, nonoxidic, acidic or basic ceramic raw materials and mixtures thereof. Particular preference is given to ceramic products based on Al₂O₃. Mixtures of these raw materials can also be present.

Particularly useful ceramic powders, in particular mixtures of ceramic powders, and also their raw materials encompass:

oxides such as BeO, MgO, Al₂O₃, SiO₂, CaO, TiO₂, Cr₂O₃, MnO, Fe₂O₃, ZnO, SrO, Y₂O₃, BaO, CeO₂, UO₂; and/or
carbides such as Be₂C, Be₄C, Al₄C₃, SiC, TiC, Cr₃C₂, Mn₃C, Fe₃C, SrC₂, YC₂, ZrC, NbC, Mo₂C, BaC₂, CeC₂, HfC, TaC, WC, UC; and/or
nitrides such as Be₃N₂, BN, Mg₃N₂, AlN, Si₃N₄, Ca₃N₂, TiN, VN, CrN, Mn₃N₂, Sr₃N₂, ZrN, NbN, Mo₃N₂, HfN, TaN, WN₂, UN; and/or
borides such as AlB₄, CaB₆, TiB₂, VB₂, CrB₂, MnB, FeB, CoB, NiB, SrB₆, YB₆, ZrB₂, NbB₂, MoB₂, BaB₆, LaB₆, CoB₆, HfB₂, TaB₂, WB, T UB₄; and/or
silicides such as CaSi, Ti₅Si₃, V₅Si₃, CrSi₂, FeSi, CoSi, ZrSi₂, NbSi₂, MoSi₂, TaSi₂, WSi₂; and/or mixtures of the abovementioned ceramic materials.

Further ceramic particles which can be used include oxidic and nonoxidic compounds, mixed phases, etc., for example mullite (Al₆Si₂O₁₃), mixed crystals from the system Al₂O₃—Cr₂O₃, MgSiO₄, CaSiO₄, ZrSiO₄, MgAl₂O₄, CaZrO₃, SIALON, ALON and/or B₄C—TiB₂.

It is also possible, according to the invention, to use ceramic particles having a nonstoichiometric composition, e.g. TiOₓ silicates, glasses and ceramic materials having a metal phase.

Ceramic particles which can be used according to the invention can also include calcined aluminas, reactive aluminas, very finely milled, refractory raw materials such as microsilica, refractory clay and/or binder clay.

For the purposes of the present invention, the term coarse refers to particle sizes of preferably ≧1 mm, particularly preferably from 1 mm to 10 mm. Medium particles are, for the purposes of the present invention, particles having sizes of from ≧0.1 mm to ≦1 mm, preferably from 0.2 mm to 0.5 mm.

For the purposes of the present invention, the term fine refers to particle sizes of preferably from 0.02 mm to ≦0.2 mm, particularly preferably from 0.02 mm to 0.1 mm. This particle size fraction is customarily also referred to as flour in technical speech.

Very fine particles are, in particular, reactive refractory components having an average particle size of ≦15 μm, preferably ≦5 μm. The minimum size of the very fine particles being 1-100 nm.

To achieve good strength properties of the ceramic products of the invention, it can be advantageous to use ceramic compositions comprising ceramic binder in combination with functional additives such as oxidic and/or nonoxidic micropowders, nanopowders, metal powders, metal, ceramic, glass, or polymer fibres and/or woven fabrics.

Particular preference is given to the ceramic composition comprising nanosize metal oxides, preferably nanosize aluminium oxide.

For some process steps and/or applications, it has been found to be advantageous to use at least some particle sizes below 1 μm, i.e. to add nanosize ceramic powders to the ceramic powder mixture.

The relatively coarse components can be present in the ceramic composition in amounts of 100% by weight, preferably in amounts of 90% by weight, particularly preferably in amounts of from 15% by weight to 80% by weight, based on the total weight of the ceramic composition.

The medium components can be present in the ceramic composition in amounts of ≦100% by weight, preferably in amounts of ≦40% by weight, particularly preferably in amounts of from 3% by weight to 20% by weight, based on the total weight of the ceramic composition.

The fine components can be present in the ceramic composition in amounts of ≦100% by weight, preferably in amounts of ≦95% by weight, particularly preferably in amounts of from 5% by weight to 80% by weight, based on the total weight of the ceramic composition.

The very fine components can be present in the ceramic composition in amounts of from ≦100% by weight, preferably in amounts of ≦50% by weight, particularly preferably in amounts of from 0.1% by weight to 35% by weight, based on the total weight of the ceramic composition.

The term “total weight of the ceramic composition” as used above relates to the ceramic composition without binder.

Preference is also given to the ceramic composition being free-flowing. The ceramic composition can have a bulk density of from 500 g/l to 2000 g/l, preferably from 600 g/l to 1800 g/l, more preferably from 700 g/l to 1600 g/l, in particular from 800 g/l to 1500 g/l and particularly preferably from 850 g/l to 1200 g/l.

Furthermore, additives, auxiliaries and/or binders selected from the group consisting of organic binders, inorganic binders, water and the like can be added to the ceramic composition.

The ceramic composition of the invention can be in the form of an injection-moulding composition, tamping composition, ramming composition, casting composition, paint or coating composition.

The ceramic powder can have particle sizes in the nanometre range and can preferably comprise oxides, carbides, nitrides, borides and/or silicides, preferably oxides of aluminium.

The ceramic composition obtained can be used directly for the process of the invention but can also be calcined in air, under reduced pressure or in an atmosphere of inert gas, carbon monoxide, carbon dioxide, nitrogen and/or hydrocarbons and the calcined moulding composition can be pulverized and used as ceramic, preferably nanosize, powder.

Particular preference is given to ceramic compositions containing ceramic powders such as magnesium silicates, aluminium silicates, spinels, silicon dioxide, magnesium oxide, calcium oxide, chromium oxide, aluminium oxide, zirconium oxide, zinc oxide, zirconium silicate, silicon carbide, SIALON. ALON, silicon nitride and/or mixtures thereof.

The ceramic compositions can additionally contain catalysts, customary auxiliaries, binders and/or additives. The ceramic compositions can, in particular, also contain small amounts of mould release agents, stabilizers and/or pigments.

Furthermore, the use of ceramic compositions containing ceramic binders in combination with hydraulic binders such as high-alumina cement, portland cement, if appropriate together with water in variable amounts, can likewise be advantageous.

The present invention further provides a process for producing ceramic products, in particular ceramic RF materials.

The process of the invention for producing shaped ceramic products can be classified quite generally into two embodiments.

In the first embodiment, the moulding composition, namely a mixture of the ceramic powder and the binder according to the invention, can firstly be pressed under a pressure of >1 MPa, preferably in the range from ≧100 MPa to ≦200 MPa, to produce a raw shaped body or green body having a defined exterior shape. Pressing can be carried out by means of conventional technologies, for example uniaxial pressing, isostatic pressing or the like. The ceramic body obtained can be used without a further thermal treatment or be subjected to subsequent firing, with a ceramic product, preferably a refractory ceramic product, being obtained.

In the second embodiment, the mixture of the ceramic powder and the reactive, liquid binder according to the invention is simultaneously shaped and heated and/or fired (hot pressing process). Here, the mixture is pressed under a pressure of >1 MPa, preferably from 5 MPa to 100 MPa, at a temperature above room temperature, preferably >50° C. Pressing can be carried out by means of conventional technologies, for example uniaxial pressing, isostatic pressing or the like. The ceramic body obtained can be used without a further thermal treatment or be subjected to subsequent firing, with a ceramic product, preferably a refractory ceramic product, being obtained.

A useful process for producing shaped ceramic products, in particular shaped refractory ceramic products, comprises the following steps:
a) mixing of reactive, liquid ceramic binders according to the invention with ceramic powder to produce a moulding composition,
b) strengthening of the moulding composition obtained from step a) by means of pressure treatment and/or thermal treatment, with a dimensionally stable ceramic product being obtained.

A further process for producing unshaped ceramic products, in particular refractory ceramic products, comprises the following steps:
a) mixing of ceramic binders according to the invention with ceramic powder;
b) if appropriate, addition of additives, auxiliaries and/or further components and/or other binders;
c) production of a ceramic composition such as a concrete composition, casting composition, tamping composition or ramming composition.

The reactive, liquid ceramic binder, in particular the liquid organomodified siloxane compound, can, based on the total weight of the ceramic powder, be present in the moulding composition or ceramic composition in a proportion by weight of from 0.01% by weight to 70% by weight, preferably from 0.1 to 50% by weight and more preferably from 0.5 to 30% by weight.

To produce ceramic composites, the mixture obtained from step a) of the process can be applied to a dimensionally stable support. The ceramic composition can subsequently be dried and/or heat-treated and/or fired. The heat resistance and/or size of the support material is, inter alia, critical in deciding whether the composite is merely dried or subjected to further thermal treatment steps such as heat treatment and/or firing.

As stated above, an additive, further component and/or binder can be added to the ceramic powder in a proportion by weight of from 0.01 to 50% by weight, preferably from 0.05 to 30% by weight and more preferably from 0.1 to 20% by weight, based on the total weight of the ceramic powder.

The green body obtained from step b) can preferably be strengthened by
drying the green body at a temperature of from 25° C. to <200° C.; and/or
heat-treating it at a temperature of from ≧200° C. to <1000° C. and/or
firing it at a temperature of ≧1000° C.

In the production of refractory products, it can also be important for the ceramic binder which is used according to the invention and contains liquid, organomodified siloxane compounds to react with other constituents of the ceramic composition, preferably the refractory ceramic composition, during the thermal treatment to form refractory compounds.

In refractory (RF) ceramic compositions which do not develop satisfactory strengths with the liquid, organomodified siloxane compounds added, a satisfactory binding force can be achieved by addition of an active ceramic powder. Aluminium oxide is particularly suitable for this purpose. Al-containing materials which form a reactive aluminium oxide after a transformation process, e.g. oxidation, are also suitable.

The reaction between the ceramic powder and the organomodified siloxane compound of the reactive, liquid ceramic binder of the invention, which reaction is responsible for bonding, can take place even at room temperature. As the temperature increases, bonding becomes stronger. Even after a thermal treatment in the intermediate temperature range from 400° C. to 1000° C. or sometimes even from 200° C. to 600° C., the ceramic products, in particular ceramic RF materials, can reach high strengths, as a result of which firing at a high temperature of >1000° C. is not necessary.

The strength of the dried and/or heat-treated and/or fired shaped body can also be increased further by impregnating it at least once with:
organomodified siloxane compounds of the reactive, liquid ceramic binder of the invention, in particular with liquid, organomodified siloxane compounds, and/or
a liquid, polymeric organosilicon compound and/or
with a solution of a solid, polymeric organosilicon compound in a solvent and/or
with a melt of a solid, polymeric organosilicon compound;
   at room temperature and/or with heating and heating it in air, under reduced pressure and/or in an atmosphere of inert gas, hydrogen, carbon monoxide, carbon dioxide, nitrogen and/or hydrocarbons to a temperature of ≧200° C. after, if necessary, the degree of impregnation has been increased by increasing the pressure.

The addition of a solvent to the ceramic binder to reduce the viscosity can aid the impregnation process.

For the purposes of the present invention, a shaped body blank is a usable green body which has a sufficiently high initial strength to be able to be handled or machined in further process steps.

In addition, green bodies can be hardened before sintering so as to obtain even stronger green bodies. Hardening can be effected by:
storage in a humid atmosphere and/or
heating to a temperature of ≧30° C. and/or
addition of suitable condensation catalysts known per se, e.g. dibutyltin dilaurate or tetrabutyl titanate.

The use of the ceramic binders of the invention, in particular ceramic binders, where the reactive, liquid ceramic binder comprises liquid, organomodified siloxane compounds, enables a sufficiently high green strength to be attained. The high dimensional stability or cold compressive strength allows the green bodies to be processed or shaped further before the final heat-treatment and/or firing step without destruction of the green bodies occurring as a result of the mechanical stress.

The green bodies can be shaped by customary processes known in the prior art. The shaped green bodies can, if desired, be shaped further by machining.

The firing process for the shaped bodies or the ceramic products can be continued until no further weight loss is observed. The duration of the firing process can be varied as a function of the temperature, the constitution of the moulding composition and the amount of the siloxanes used according to the invention in the moulding composition.

Constant weight is usually achieved after from 1 to 24 hours at temperatures of >400° C.

It has surprisingly been found that when use is made of the ceramic binders of the invention, where the reactive, liquid ceramic binder preferably comprises liquid, organomodified siloxane compounds, and the moulding compositions of the invention containing the reactive, liquid ceramic binder, firing of fracture-free ceramic products having excellent physical and mechanical properties can be achieved
in a relatively short time at the same firing temperatures; and/or
at relatively low firing temperatures in comparable times.

The production of shaped ceramic products such as firebricks can comprise the steps:
production of a homogeneous ceramic composition, in particular a moulding composition, comprising refractory ceramic particles and ceramic binders according to the invention; if appropriate, addition of a reactive aluminium oxide or an Al-containing material;
if appropriate, addition of water or another binder and homogenization of the ceramic mixture or moulding composition;
if appropriate, addition of additives and further homogenization of the mixture or moulded composition;
if appropriate, further components which perform particular functions in the finished bricks are incorporated into the mixture. Suitable further components are, for example, metal powders which improve the oxidation resistance of a nonoxidic ceramic product, in particular a ceramic RF material; pressing of the homogeneous refractory moulding composition to produce defined brick formats. Preference is given to pressing pressures of from ≧100 MPa to ≦200 MPa;
drying and/or heat treatment of the pressed bricks at temperatures of >50° C.; and/or firing of the dried and/or heat-treated bricks at temperatures of ≧400° C.

The production of the unshaped refractory products of the invention can be carried out at the premises of the refractory manufacturer or in-situ by the refractory user, preferably in the following steps:
production of a homogeneous ceramic composition;
if appropriate, addition of an active aluminium oxide or an Al-containing material;
if appropriate, addition of a binder, additives and/or water and homogenization of the mix;
if appropriate, addition of further components and continued homogenization of the mix.

If required, further components which perform particular functions in the finished moulding compositions are incorporated into this mixture. Examples of further components are metal powders and nonoxidic materials such as carbon, carbides, nitrides, silicides, metal fibres, polymer fibres, carbon fibres which effect a further improvement in the oxidation resistance, strength, drying behaviour, corrosion resistance and/or thermal shock resistance of the ceramic product.

Ceramic compositions, in particular homogeneous ceramic compositions, can be processed by means of techniques customary in refractory technology, e.g. pressing, casting, vibrating, spraying, guniting, tamping and the like to give a ceramic product, including RF materials, monolithic refractory linings, etc.

Finished parts can also be produced from the moulding compositions of the invention, e.g. refractory moulding compositions. For this purpose, the moulding compositions produced as described above are introduced into a metal, wooden or plastic mould. The composition can be additionally densified by subsequent vibration, tamping, pressing, etc. After curing of the composition, the part is removed from the mould and dried and/or heat treated at from 30° C. to 200° C. If required, the dried or heat-treated part can be fired. The firing conditions depend essentially on the chemical and mineralogical make-up of the refractory composition and also on the shape and geometry of the part. In general, firing at temperatures of ≦1600° C. is sufficient. After drying, heat treatment and/or firing, the finished ceramic parts according to the invention, in particular RF materials, can be ready-to-use.

The degree of curing is dependent on the shape of the ceramic product. In any case, the shaped ceramic body is cured until it has the strength necessary to avoid a change in shape during the firing process.

The shaped and unshaped ceramic products of the invention, e.g. refractory materials, can be used in furnaces and plants of the nonferrous metals industry, steel industry, cement industry, glass industry, waste incineration plants, etc.

Although the inventive organomodified siloxanes of the ceramic binder are preferably suitable as binders for ceramic compositions, their use is not restricted thereto. They can also be used in casting and pressing compositions, in painting compositions for electrical insulation and in protective coating compositions for metal surfaces.

The present invention further provides the ceramic product, in particular dimensionally stable ceramic product, itself.

According to the invention, it has been found that use of the binder according to the invention makes it possible to produce ceramic products, in particular ceramic compositions, which can be dimensionally stable from ceramic powder at room temperature or temperatures of <30° C. and processing times of a number of hours or days. Such ceramic products, in particular ceramic compositions, can have good cold compressive strength.

Particularly preferred ceramic products are refractory ceramic products.

The ceramic product can be shaped or unshaped.

Dimensionally stable ceramic products produced according to the invention under a pressing pressure of 100 MPa can have a cold compressive strength after heat treatment for 2 hours at 100° C. to ≦1000° C., preferably ≦700° C., of ≧15 MPa.

Further subjects of the present invention are described by the claims.

The reactive ceramic binders of the invention and their use are illustrated below by way of example without the invention being restricted to these illustrative embodiments.

If ranges, general formulae or classes of compounds are indicated below, these are intended to encompass not only the respective ranges or groups of compounds which are explicitly mentioned but also all subranges and subgroups of compounds which can be obtained by leaving out individual values (ranges) or compounds.

### EXAMPLES

The present invention is illustrated by way of example in the examples described below without the invention, whose scope is defined by the total description and the claims, being restricted to the embodiments described in the examples.

The production and properties of the products according to the invention are illustrated below with the aid of examples.

### Preparation of Siloxane Compounds According to the Invention:

### Compound A:

381 g of an SiH-functional siloxane of the general formula Me₃SiO—(SiMe₂O)₁₃—(SiMeHO)₅—SiMe₃ were placed in a 1 l three-necked flask, heated to 120° C. and admixed with 10 ppm of a platinum catalyst. 327 g of triethoxy-vinylsilane were then slowly added. The mixture was stirred for another 1 hour at 125° C. and the excess olefin was subsequently removed by distillation at 130° C. in an oil pump vacuum.

### Compound B:

433 g of an SiH-functional siloxane of the general formula Me₃SiO—(SiMe₂O)₁₃—(SiMeHO)₅—SiMe₃ were placed in a 1 l three-necked flask, heated to 120° C. and admixed with 10 ppm of a platinum catalyst. 289 g of trimethoxy-vinylsilane were then slowly added. The mixture was stirred for another 1 hour at 125° C. and the excess olefin was subsequently removed by distillation at 130° C. in an oil pump vacuum.

### Compound C:

146 g of triethoxyvinylsilane and 48 g of 4-vinyl-1-cyclohexene 1,2-epoxide were placed in a 500 ml three-necked flask, heated to 120° C. and admixed with 10 ppm of a platinum catalyst. 231 g of an SiH-functional siloxane of the general formula Me₃SiO—(SiMe₂O)₂₈—(SiMeHO)₁₅—SiMe₃ were then slowly added. The mixture was stirred for another 2 hours at this temperature and the excess olefin was subsequently removed by distillation at 130° C. in an oil pump vacuum.

### Compound D:

674 g of an SiH-functional siloxane of the general formula Me₃SiO—(SiMe₂O)₈₉—(SiMeHO)₉—SiMe₃ were placed in a 1 l three-necked flask, heated to 120° C. and admixed with 10 ppm of a platinum catalyst. 160 g of trimethoxy-vinylsilane were then slowly added. The mixture was stirred for another 1 hour at 125° C. and the excess olefin was subsequently removed by distillation at 130° C. in an oil pump vacuum.

### Compound E:

382 g of an SiH-functional siloxane of the general formula (HMe₂SiO_{1/2})₃ (SiMe₂O_{2/2})₁₂₀(SiMeHO_{2/2})₂₄(SiPhO_{3/2}) were placed in a 1 l three-necked flask, heated to 120° C. and admixed with 10 ppm of a platinum catalyst. 223 g of trimethoxyvinylsilane were then slowly added. The mixture was stirred for another 1 hour at 125° C. and the excess olefin was subsequently removed by distillation at 130° C. in an oil pump vacuum.

### Compound F:

181 g of an SiH-functional siloxane of the general formula (HMe₂SiO_{1/2})₂(SiMe₂O_{2/2})₁₃(SiMeHO_{2/2})₆ were placed in a 500 ml three-necked flask, heated to 120° C. and admixed with 10 ppm of a platinum catalyst. 247 g of trimethoxyvinylsilane were then slowly added. The mixture was stirred for another 3 hours at 125° C. and the excess olefin was subsequently removed by distillation at 130° C. in an oil pump vacuum.

Compound G:

148 g of triethoxyvinylsilane and 41 g of styrene were placed in a 500 ml three-necked flask, heated to 120° C. and admixed with 10 ppm of a platinum catalyst. 233 g of an SiH-functional siloxane of the general formula Me₃SiO—(SiMe₂O)₂₈—(SiMeHO)₁₅—SiMe₃ were then slowly added. The mixture was stirred for 3 hours at a temperature of 125° C., another 10 g of styrene and 35 g of triethoxyvinylsilane were introduced and the mixture was stirred for another 1.5 hours at 125° C. The excess olefin was subsequently removed by distillation at 130° C. in an oil pump vacuum.

### Compound H (not According to the Invention):

A further liquid, organomodified siloxane compound was prepared as described in DE 10 2006 020 967 (US 2008-034794).

This has the average formula (II)

R¹ₐSiO_{(4-a-b)/2}(OR²)_{b} (II)

where
a=1.0
b=0.4
R¹=methyl, R²=ethyl.

### Example 1

### Binding Power in α-Alumina Bricks

A high-purity sintered α-alumina, T60 obtainable from ALMATIS GmbH in Ludwigshafen, having the following particle distribution:

| | | |
|---|---|---|
| coarse particles | from 1 to 2 mm | 50% by weight |
| medium particles | from 0.2 to 0.5 mm | 10% by weight |
| flour | <0.1 mm | 40% by weight |

was homogeneously mixed with 4 parts by weight of the compound A. For comparison, a moulding composition containing 4 parts by weight of sulphite liquor (without compound A) and a moulding composition containing 4 parts by weight of the compound H which is not according to the invention were produced. Test specimens were produced from the mixtures under a pressing pressure of 100 MPa and subsequently fired for 2 hours at 600 and 1500° C. After firing, the test specimens had the following properties:

| | Cold compressive | Cold compressive |
|---|---|---|
| | strength/MPa (in | strength/MPa (in |
| | accordance with | accordance with |
| | DIN EN 993-1) | DIN EN 993-1) |
| | 600° C. | 1500° C. |
| Without compound A | <5 | <25 |
| With compound A | >15 | >110 |
| With compound H | >40 | <100 |
| (not according to | | |
| the invention) | | |

It can be seen that the addition of compound A brings about a significant increase in the strength of the ceramic. Compared to compound H, there is a significant advantage especially at high firing temperatures.

### Example 2

### Binding Power of Various Compounds

A high-purity sintered α-alumina, T60 obtainable from ALMATIS GmbH in Ludwigshafen, having the following particle distribution:

| | | |
|---|---|---|
| coarse particles | from 1 to 2 mm | 50% by weight |
| medium particles | from 0.2 to 0.5 mm | 10% by weight |
| flour | <0.1 mm | 40% by weight |

was homogeneously mixed with in each case 4 parts by weight of the compounds A, B and C. Test specimens were produced from the mixtures under a pressing pressure of 100 MPa and subsequently fired for 2 hours at 600° C. After firing, the test specimens had the following properties:

| | Cold compressive |
|---|---|
| | strength (MPa) (in |
| | accordance with |
| Compound | DIN EN 993-1) |
| A | >15 |
| B | >20 |
| C | >15 |
| D | >20 |
| E | >20 |
| F | >25 |
| G | >20 |

The addition of compounds A to G brings about a large increase in the strength of the α-alumina bricks.

Having thus described in detail various embodiments of the present invention, it is to be understood that the invention defined by the above paragraphs is not to be limited to particular details set forth in the above description as many apparent variations thereof are possible without departing from the spirit or scope of the present invention.

1. A reactive ceramic binder in liquid form which produces ceramic products from ceramic powder, characterized in that the reactive, liquid ceramic binder comprises liquid organomodified siloxane compounds having organoalkoxysiloxane units of the general formula (I) 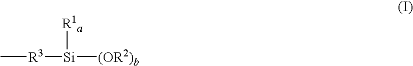
where
the radicals R¹ are, independently of one another, identical or different alkyl, alkaryl or aryl radicals which may be interrupted by ether functions,
the radicals R² are, independently of one another, identical or different radicals selected from the group consisting of H and/or alkyl radicals having from 1 to 6 carbon atoms,
the radicals R³ are, independently of one another, identical or different divalent, saturated or unsaturated hydrocarbon radicals which have from 1 to 30 carbon atoms and may be interrupted by ether functions and
a is greater than or equal to 0 and less than or equal to 2.5 and
b is greater than 0 and less than or equal to 3,
with the proviso that a+b is greater than or equal to 1 and less than or equal to 3.

2. The ceramic binder according to claim 1, wherein the proportion of H in R² of the organomodified siloxane compound is from ≧0% to ≦10%.

3. The ceramic binder according to claim 1, wherein
the radicals R¹ being a phenyl and/or a C₁-C₁₆-alkyl radical, and/or
the radicals R² are each H, methyl, ethyl, propyl, isopropyl, butyl, tert-butyl,
R³ is —(CH₂)ₙ— where n=1 to 11.

4. The ceramic binder of claim 3, wherein a is 0.

5. The ceramic binder of claim 3, wherein R¹ is a methyl group.

6. Ceramic binder according to claim 1, wherein a is from 0 to 2, with the proviso that a+b is less than or equal to 3.

7. Ceramic binder according to claim 1, wherein b is from 0.1 to 3, with the proviso that a+b is less than or equal to 3.

8. Ceramic binder according to claim 1, wherein the reactive, liquid ceramic binder contains a solvent selected from the group consisting of organic solvents.

9. Ceramic binder according to claim 1, wherein the reactive, liquid ceramic binder contains alcohol or acetone or a mixture thereof as solvent.

10. Ceramic binder according to claim 1, wherein the reactive liquid ceramic binder contains water and is preferably in the form of an aqueous emulsion.

11. Ceramic binder according to claim 1, wherein the organomodified siloxane compounds have a number average molecular weight of from 500 to 20 000 g/mol.

12. Ceramic binder according to claim 1, wherein at least one additive has been added to the ceramic binder, with this additive being different from the liquid organomodified siloxane compound(s) based on the formula (I) and being selected from the group consisting of an inorganic binder, an inorganic salt of sulphuric acid, an inorganic salt of hydrochloric acid, an inorganic salt of phosphoric acid, magnesium chloride, magnesium sulphate, monoaluminium phosphate, alkali metal phosphate, alkali metal silicate, water glass, an organic binder, cellulose derivative, polyvinyl alcohol, water, organic solvents, mould release agents, stabilizers, organic pigments, inorganic pigments, oxides, metal oxides, nonoxidic materials, carbon, metal powders, metal fibres, ceramic fibres, glass fibres, natural fibres, synthetic fibres, carbides, nitrides, silicides, polymers, fluidizers, setting retarders, setting accelerators, pressing aids, lubricants, thickeners, antifoams, sinter aids, catalysts and/or carbon fibres, nanosize metal oxides, and nanosize aluminium oxide.

13. A method of producing a ceramic product selected from the group consisting of dimensionally stable ceramic products and unshaped ceramic products which comprises of adding the ceramic binder of claim 1 to a ceramic powder.

14. The method of claim 13, wherein the dimensionally stable ceramic products is selected from the group consisting of refractory ceramic products, pressed dimensionally stable ceramic products and heat-treated dimensionally stable ceramic products.

15. The method of claim 13, wherein the unshaped ceramic product is an unshaped refractory ceramic product.

16. The method of claim 13, wherein the organomodified siloxane compounds of the ceramic binder are added to the ceramic powder in a proportion by weight of from 0.01 to 70% by weight, based on the total weight of the ceramic powder.

17. A ceramic composition comprising ceramic binders according to claim 1 and ceramic powder.

18. The ceramic composition according to claim 17 comprising nanosize metal oxides.

19. The ceramic composition according to claim 17, which has a bulk density of from 500 g/l to 2000 g/l.

20. The ceramic composition according to claims 17 which comprises further components selected from the group consisting of organic binders and inorganic binders.

21. The ceramic composition according to claim 17 which is an injection-moulding composition, tamping composition, concrete composition, ramming composition, casting composition, paint or coating composition.

22. The process for producing shaped dimensionally stable ceramic products, in particular refractory dimensionally stable ceramic products, characterized in that the process comprises the following steps
a) mixing of ceramic binders according to claim 1 with ceramic powder to produce a moulding composition,
b) strengthening of the moulding composition obtained from step a) by means of pressure treatment and/or thermal treatment, with a dimensionally stable ceramic product being obtained.

23. The process according to claim 22, wherein the reactive, liquid ceramic binder is, based on the total weight of the ceramic powder, present in the moulding composition in a proportion by weight of from 0.01 to 70% by weight.

24. The process according to claim 22, wherein the mixture obtained from step a) is applied to a dimensionally stable support.

25. The process according to claim 22, wherein an additive, further component and/or binder is additionally added to the ceramic powder, with preference being given to adding nanosize metal oxides to the ceramic powder.

26. The process according to claim 22, wherein the mixture obtained from step a) is strengthened by
drying the ceramic composition at a temperature of from 50° C. to <200° C.; and/or
heat-treating it at a temperature of from 200° C. to <1000° C. and/or
firing it at a temperature of 1000° C.

27. A process for producing unshaped ceramic products, in particular refractory ceramic products, characterized in that the process comprises the following steps
a) mixing of a reactive, liquid ceramic binder according to claim 1 with ceramic powder;
b) if appropriate, addition of additives, auxiliaries and/or further components and/or other binders;
c) production of a ceramic composition such as a concrete composition, casting composition, tamping composition or ramming composition.

28. The process according to claim 27, wherein the reactive, liquid ceramic binder is, based on the total weight of the ceramic powder, present in the ceramic composition in a proportion by weight of from 0.01 to 70% by weight.

29. A ceramic product which can be produced according to claim 22.
